(19) United States
(12) Patent Application Publication
(10) Pub. No.: US 2017/0032408 A1
(43) Pub. Date: Feb. 2, 2017

(54) AUTOMATED SUBSCRIBER ENGAGEMENT

(71) Applicants: Ankesh Kumar, Palo Alto, CA (US); Aleksey Sergeyevich Nazarov, San Mateo, CA (US)

(72) Inventors: Ankesh Kumar, Palo Alto, CA (US); Aleksey Sergeyevich Nazarov, San Mateo, CA (US)

(73) Assignee: Socialmail LLC, Palo Alto, CA (US)

(21) Appl. No.: 15/169,707

(22) Filed: May 31, 2016

Related U.S. Application Data
(63) Continuation-in-part of application No. 14/485,013, filed on Sep. 12, 2014.
Application No. 14/485,013 is a continuation-in-part of application No. 14/049,204, filed on Oct. 8, 2013, now Pat. No. 9,521,100.
Application No. 14/049,204 is a continuation-in-part of application No. 13/712,870, filed on Dec. 12, 2012.
Application No. 13/712,870 is a continuation-in-part of application No. 13/191,412, filed on Jul. 26, 2011.

(51) Int. Cl. G06Q 30/02; H04L 12/58

(52) U.S. Cl. CPC G06Q 30/0244; G06Q 30/0255; G06Q 30/0246; G06Q 30/0277; H04L 51/18; H04L 67/306

(57) ABSTRACT

A user who is subscribed to content from a publisher may become disengaged due to lack of activity. In a content management system, user information associated with a disengaged user is received from a partner system. An account creation request is generated based on the user information and one or more unread content items associated with the disengaged user is determined from the partner system. A message comprising a selection of the one or more unread content items is generated and configured to be customizable. The message is then communicated to the disengaged user using the user information. Advertisements may be targeted to disengaged users based on interests associated with subscriptions and interactions with content.

### CROSS-REFERENCE TO RELATED APPLICATIONS

This application is a continuation-in-part of U.S. Non-Provisional patent application Ser. No. 14/485,013 (Atty. Docket No. SOC-001CIP3), filed Sep. 12, 2014, which is a continuation-in-part of U.S. Non-Provisional patent application Ser. No. 14/049,204 (Atty. Docket No. SOC-001CIP2) filed Oct. 8, 2013, which is a continuation-in-part of U.S. Non-Provisional patent application Ser. No. 13/712,870 (Atty. Docket No. SOC-001CIP1), filed Dec. 12, 2012, which is a continuation-in-part of U.S. Non-Provisional patent application Ser. No. 13/191,412 (Atty. Docket No. SOC-001), filed Jul. 26, 2011. All of the above-referenced properties are herein incorporated by reference in their entirety for all purposes.

### FIELD

The present application relates generally to computer software, computer program architecture, data and database management, professional media, social media, web based applications, and mobile applications. More specifically, techniques for electronic mail processing and publication for a visual display oriented email system are described.

### BACKGROUND

Electronic messaging is an important function for garnering data for personal consumption and for sharing data with other individuals, organizations, or entities. Conventional electronic messaging solutions such as electronic mail (hereafter “email”) applications, servers, and platforms allow users to receive email, compose email, forward email, send email, carbon copy (cc) email, blind cc email and reply to email. Moreover, reviewing content included in an email often requires several “click-throughs” of a mouse or other user interface device to access the content. For example, one click through may be necessary to open an email in a user's inbox or other email folder, another click through may be necessary to access a web page/site in a hyperlink or image included in a body of the email message. It is estimated that for each click through required to access email content, one-third of users are lost (e.g., choose not to access content). From a user point of view, an inbox or other email folder may contain an overwhelming amount of visual information created by a large number of email messages from a large number of different email sources, such as advertisers, businesses, financial institutions, invoices for bills, newsletters, social networks, professional networks, special interests groups, friends, colleagues and family, just to name a few.

In some instances there may be redundant emails from the same source and/or there may be emails from sources the user is subscribed to but is no longer interested in receiving. In any case, visually parsing through the disparate assembly of email messages and the concomitant click troughs that may be required to access the content of each email may result in the user unsubscribing from an email source or ignoring email from an email source due to the number of required interactions (e.g., click-throughs) to access content. The unsubscribe requests from users may be regarded as a “churn rate” that is undesirable for a publisher or other source of the email.

On a weekly basis, if a publisher has a 0.3% churn rate, then that publisher may lose 5% of its subscribers on an annual basis with a concomitant loss of revenue to the publisher from advertising, etc. In many cases, the unsubscribing user may actually like the content being provided by the publisher, but is compelled to downsize the amount of emails that he/she is receiving due to an overwhelming amount of emails being received from many disparate sources and the burden of having to visually sort through and decide which emails to react to or to ignore or delete. For example, faced with a large number of emails in an inbox, a user may permanently delete emails they regard as less important. As another example, a user has subscribed to a source of emails (e.g., a newsletter, etc.) and those emails are received in the user's inbox. The user may actually want to receive the subscribed to emails, but doesn't want them in their regular inbox. Due to email overload, the user may inadvertently unsubscribe from the emails even though they initially subscribed to the emails and may actually still want to receive them.

Conventional presentation of email messages using a subject line format may not convey enough useful information to allow a user to decide whether or not to open the email to divine its content. For example, an email may include text and images; however, the user may not see the image portion until at least one or more click troughs, and the image portion of the content, if known without having to click through, may be more informative to the user in making a decision to dive further into the content of an email message or to ignore or delete the email message, as opposed to just the text presented in the subject line. In other cases, the visual parsing of a folder or inbox may be fatiguing to a user and result in the user overlooking an email of interest because it is not visually prominent and/or noticeable when presented among other emails in that folder or inbox.

Users (e.g., about 47%) may unsubscribe from email content that they may actually like because they are overwhelmed by the numerous amount of emails they receive (e.g., newsletters, marketing collateral, news, information, media, etc.) and that accumulate in their inboxes or other email folders over time. Retention marketing is a concept in which a marketer acts to retain as may users as possible. For example, if each publication of new content from a publisher elicits about 0.03 users to unsubscribe, then over time, that publisher may lose many users due to their unsubscribing from the publishers content.

Thus, what is needed is a solution that provides publishers with an alternative forum for presentation of content to those disengaged users.

### BRIEF DESCRIPTION OF THE DRAWINGS

Various embodiments or examples (“examples”) are disclosed in the following detailed description and the accompanying drawings:

FIG. 1 illustrates a high-level block diagram depicting a process of automated subscriber engagement using a content management system, according to an embodiment;

FIG. 2 is a network diagram of a system for automated subscriber engagement in a content management system, showing a block diagram of the content management system, according to an embodiment;

FIG. 3 is an interaction flow diagram illustrating a process for automated subscriber engagement in a content management system, according to an embodiment;

FIG. 4 is a high-level block diagram illustrating a process for automated subscriber engagement in a content management system, according to an embodiment;

FIG. 5 is a flow chart of a process for engaging subscribers using a content management system, according to some examples;

FIG. 6 is a flow chart of a process for targeting subscribers for advertising using a content management system, according to some examples; and

FIG. 7 illustrates an exemplary computing platform disposed in a device configured to provide automated subscriber engagement in accordance with various embodiments.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement the described techniques. Database management systems (i.e., “DBMS”), search facilities and platforms, web crawlers (i.e., computer programs that automatically or semi-automatically visit, index, archive or copy content from, various websites (hereafter referred to as “crawlers”)), and other features may be implemented using various types of proprietary or open source technologies, including MySQL, Oracle (from Oracle of Redwood Shores, Calif.), Solr and Nutch from The Apache Software Foundation of Forest Hill, Md., among others and without limitation. The described techniques may be varied and are not limited to the examples or descriptions provided.

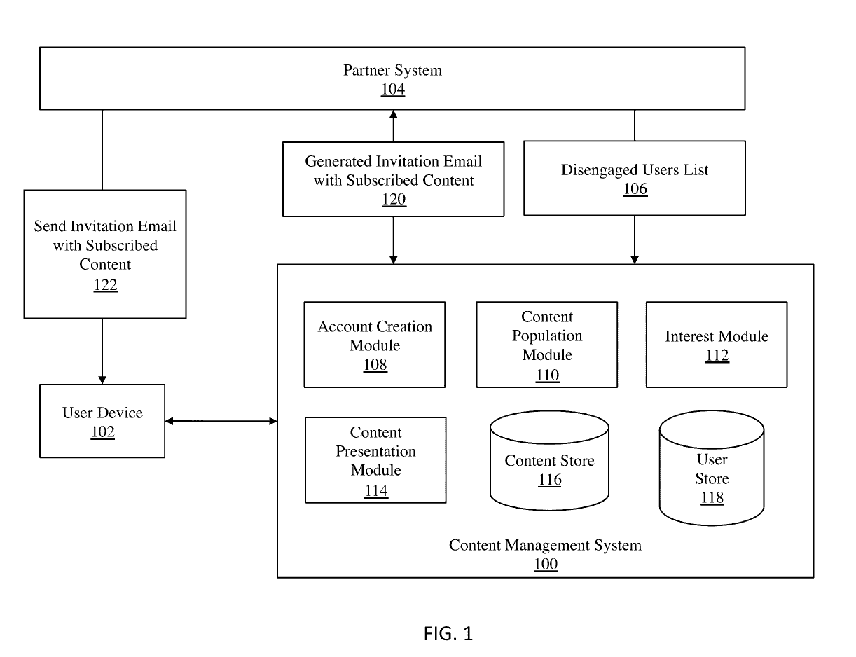

FIG. 1 illustrates a high-level block diagram depicting a process of automated subscriber engagement using a content management system, according to an embodiment. A content management system 100 may interact with a user device 102 and a partner system 104 to communicate and engage with users that had previously subscribed to content. For example, users may have previously subscribed to newsletters, promotional emails, and/or offers and discounts from a brand partner, such as a retailer, manufacturer, deal marketplace, and the like. Data representing attributes of the users may be stored in the content management system 100, such as data representing the newsletters, promotional emails, and/or offers and discounts, as well as data representing the one or more interests extracted from the content as well as the brand partner, such as the retailer, manufacturer, deal marketplace, and the like. Administrators of a partner system 104 may generate a list of disengaged users 106, independent of the content management system 100, in an embodiment. For example, a list of disengaged users 106 may be generated by partners tracking whether emails and/or other messages sent to users were opened and/or clicked upon. Other data representing email marketing metrics may be used to generate the list of disengaged users 106, such as a time period since a user last engaged with content, such as 90 days or 180 days without opening an email, or a number of unopened content items, such as 10 delivered emails that have not been opened. In other embodiments, a list of disengaged users 106 may be generated by the content management system 100 using this data representing email marketing metrics or otherwise delivered to the content management system 100. The list of disengaged users 106 may include names and email addresses and may be encrypted. In other embodiments, the list of disengaged users 106 may include other contact information, such as phone numbers, social media account usernames, and so forth. In this way, a disengaged user is now specified by data received by the content management system 100, such as the list of names and email addresses and/or other contact information.

A content management system 100 may include an account creation module 108, a content population module 110, an interest module 112, a content presentation module 114, a content store 116, and a user store 118, for example. A partner system 104 may interact directly with a user device 102 or indirectly with a user device 102 through a content management system 100. After the list of disengaged users 106 is delivered to a content management system 100, accounts may be created for the disengaged users by email address. The account creation module 108 may generate a username for each disengaged user by email address, in one embodiment, by uniquely creating a username using the prefix of the existing email address associated with the disengaged user. This enables the user to readily identify that the account username is associated with the content management system 100, such as USER@Socialmail.com.

A content population module 110 may populate each new account with subscribed content that was unopened by the user, such as the last 5 emails sent to the user. In one embodiment, the partner system 104 may send the subscribed content to the content management system 100 for population of the new accounts. In other embodiments, the content management system 100 may access subscribed content, via pointers, references, and/or uniform resource locators (URLs), as provided by the partner system 104. In another embodiment, subscribed content associated with the partner system 104 may be retrieved from a content store 116. In a further embodiment, other content associated with the partner system 104, such as offers, discounts, and promotional content, may be used by the content population module 110 to populate the new user accounts with content.

An interest module 112 may associate interests to a user account in a user store 118. For example, a newly created user account may be associated with the partner system 104 that includes the user in a list of disengaged users 106. Interests may also be categorized by the interest module 112, such as travel, deals, retail, events, and so forth. A partner system 104 may include a retailer, such as REI, that has users subscribed to newsletters about ski jackets. The interest module 112 may extract interests from subscribed content emails associated with a partner system 104 or from other content used to populate user accounts, such as text messages, social media messages, advertisements, coupons, and so forth. Returning to the above example, the interest module 112 may associate an interest in REI, the partner system 104, along with broader categories of interest, such as retail and travel, based on interests extracted from unopened emails about ski jackets. In other embodiments, a newly created user account may only be associated with an interest in the brand by the interest module 112 in the user store 118. Other types of partner systems 104 may include publications, magazines, concert venues, politicians, individuals, businesses, non-profit organizations, and any other type of entity that publishes subscription content.

A content presentation module 114 may generate an invitation email with subscribed content 120 based on the content delivered to the content management system 100, as described above. For example, the partner system 100 may have provided the content management system 100 with a number of recently published content, such as the last 5 emails unopened by subscribers. In another embodiment, content may be retrieved from the content store 116 that was previously associated with the partner system 104. In a further embodiment, content may be retrieved from the partner system 104 in the generated invitation email 120. The content presentation module 114 may further enable administrators of the partner system 104 to opt the newly created user accounts into other subscriptions, such as deals, offers, promotional materials, and so forth. The generated invitation email may include the username and password for the newly created user account. The partner system 104 may then send the invitation email with subscribed content 122 to the user device 102 directly or indirectly through the content management system 100. The invitation email may include a link to fully activate the partially activated account created on the content management system 100. If the link is not clicked on within a set time period, such as 72 hours, the link may then become inactive and the partially activated account may be deleted and/or marked for deletion in the content management system 100.

Here, a content management system 100 includes various modules, databases, and websites. As shown, the type, quantity, configuration, topology, and other characteristics are provided for purposes of illustration only and may be varied beyond the examples shown and provided. Databases, in some examples, may be directly or indirectly in data communication with servers, which may be implemented as described above to perform one or more applications, deliver services or resources to clients, execute or compile applications, or otherwise provide any type of processing capability or facility, without limitation. Data associated with the techniques described herein may be stored in one or both of databases. In other examples, data may also be stored in embedded memory, of any type, with servers or clients. Still further, data may be stored and retrieved by servers or clients from databases without limitation as to any given database schema or structure. For example, an email may be transmitted to a “shared destination,” which may be an email server, email account, or other resource that is configured to accept email messages sent using messaging protocols such as Simple Mail Transfer Protocol (hereafter “SMTP”) and received using other protocols such as Internet Message Access Protocol (hereafter “IMAP”) or Post Office Protocol (hereafter “POP”), among others. In some examples, email receipt may be indicated automatically or semi-automatically to a server. In other examples, received emails sent to an email account or client may be retrieved periodically based on a set or irregular schedule. For example, an application hosted and running on a server may be configured to retrieve emails for further processing, as described below, on a set schedule (e.g., every 1, 5, 30, 60 minutes, or the like). Using various types of email receipt protocols (e.g., IMAP, POP, or others), emails may be retrieved from an email account or shared destination. Once retrieved by a server, emails may be stored in database and processed further to generated processed messages for posting to a shared environment (e.g., websites). As used herein, an email account to which emails are sent for posting in a shared environment may be referred to as a “shared destination.”

A shared destination may be, in some examples, an email account hosted on a server that is configured to receive emails sent from various sources and intended for posting to a given website. Data associated with emails sent to a shared destination may be stored in a database or, in other examples, remotely stored.

A website may be described as a “shared environment” or facility to which data, information, or other content may be posted or published. As used herein, “posting” or “publication” may be used interchangeably and are intended to refer to the format, transmission, upload, design, layout, and other parameters of content manipulated relative to a given environment. In some examples, a website may be a Internet destination at which emails, attachments, data, information, or other types of content may be viewed, retrieved, posted, or deleted, without limitation. In other examples, content management system 100 and the above-described elements may be varied in function, structure, configuration, topology, quantity, type, or other aspects and are not limited to the examples shown.

### System Architecture

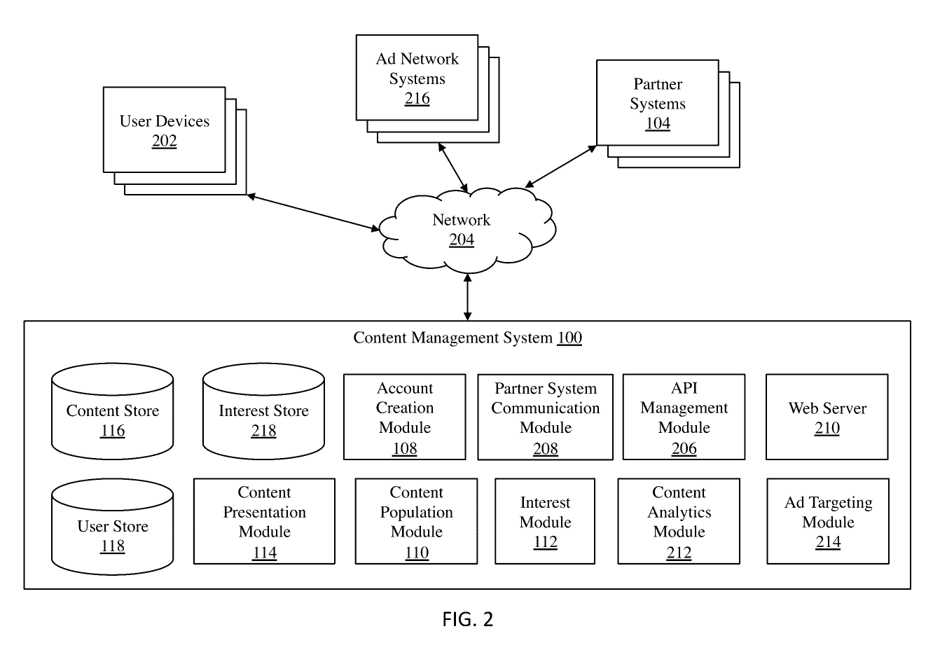

FIG. 2 is a network diagram of a system for automated subscriber engagement in a content management system, showing a block diagram of the content management system, according to an embodiment. The system environment includes one or more user devices 202, ad network systems 216, partner systems 104, the content management system 100, and a network 204. In alternative configurations, different and/or additional modules can be included in the system.

The user devices 202 may include one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, wearable device, etc. The user device 202 is configured to communicate via network 204. The user device 102 or developer system 120 can execute an application, for example, a browser application that allows a user of the user device 202 to interact with the content management system 100. In another embodiment, the user device 202 interacts with the content management system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multi protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the content management system 100. The content management system 100 includes a content store 116, an interest store 218, a user store 118, a content presentation module 114, an account creation module 108, a partner system communication module 208, a content population module 110, an interest module 112, a web server 210, an API management module 206, a content analytics module 212, and an ad targeting module 214. In other embodiments, the content management system 100 may include additional, fewer, or different modules for various applications. Conventional components such as network interfaces, security functions, load balancers, failover servers, management and network operations consoles, and the like are not shown so as to not obscure the details of the system.

The web server 210 links the content management system 100 via the network 204 to one or more user devices 202; the web server 210 serves web pages, as well as other web-related content, such as Java, Flash, XML, and so forth. The web server 210 may provide the functionality of receiving and routing messages between the content management system 100 and the user devices 202, for example, instant messages, queued messages (e.g., email), text and SMS (short message service) messages, or messages sent using any other suitable messaging technique. The user can send a request to the web server 210 to upload information, for example, content that is stored in a content store 116. Additionally, the web server 210 may provide API functionality to send data directly to native user device operating systems, such as iOS, ANDROID, webOS, and RIM.

A content store 116 may store content uploaded to the content management system 100. Content may include subscribed content, such as subscription emails, newsletters, daily deals and offers, promotional content, and so forth. Content may be personalized based on profile information about a user, such as geographic location and demographic information, in one embodiment. Content may include text, audio/video content, linked web content, and so forth.

An interest store 218 may include a structured categorization of interests in a content management system 100. In one embodiment, interest information may be categorized in a structured manner in a content management system 100. An interest may be assigned a unique identifier such that related interests are associated with a broader interest as stored in the interest store 218. As an example, sporting goods may be a broad category interest, where ski equipment and other ski-related goods may be further categorized with the broad category interest of sporting goods. Further, brands may be uniquely identified as separate interests in the interest store 218. In another embodiment, interest information may be stored in various methods, such as a flat text file, a spreadsheet, an XML file, and so forth. The interest store 218 may also include data stored as unstructured data.

A user store 118 may include information about users of the content management system 100. Upon creation of an account by the account creation module 108, information associated with a dis-engaged user may be stored in the user store 118, including personally identifiable information such as name and email address. In one embodiment, the information about users may be encrypted. In another embodiment, other information about the users of the content management system 100 may be stored in the user store 118, such as social media usernames, demographic information, location information, contact information, and images associated with the user available through one or more social networking systems. Interest information stored in the interest store 218 may be associated with users and store in user profiles in the user store 118.

An account creation module 108 may be used to create accounts for disengaged users based on email addresses provided by a partner system 104. Account creation may involve generating a user profile in a user store 118 and associating an interest in the partner brand associated with the partner system 104. Other information about the user may be stored in the user profile in the user store 118, such as demographic information, location information, other contact information, and other information about the user as provided by the partner system 104 and/or gathered or collected through other sources. After an account is created and activated by a user, the user may edit or modify information shared with the content management system 100, in one embodiment. In another embodiment, the user may further synchronize an email account with the user account generated by the account creation module 108 such that the content management system 100 may manage promotional content through the content presentation module 114. In a further embodiment, a user may interface with the content management system 100 through a mobile application to browse through subscribed content.

A partner system communication module 208 may enable partners to directly communicate with users via the content management system 100. A mobile application may provide subscribed content in a different format, such as an infinite scroll through with aggregated views of content may be displayed to users. For example, the mobile application may present, in a continuous, contiguous, and/or refreshing feed in response to user interactions, extracted images and text from the subscribed content, such as the marketing text and images in each email. As a result, an aggregated view of content is displayed in the mobile application in the continuous feed. In one embodiment, the feed may refresh to aggregate additional subscribed content in response to a user interaction with the feed, such as scrolling through the feed, so that it appears that the feed goes on “infinitely,” where the mobile application thus provides an infinite scroll. During the “refresh,” additional subscribed content is requested from the partner system communication module 208 via the content management system 100, as an example. The subscribed content may have originally existed in multiple emails, but may have been aggregated and extracted to form the infinite scroll feed in the mobile application, where the images and text may be resized to fit the mobile application form factor, for example. In one embodiment, partners may enable their content to be published in a category view, such as deals that are expiring soon, travel, and fashion. The partner system communication module 208 may provide partners with a portal or other interface to configure settings associated with the brand, such as categorization of subscriptions, opt-in of subscriptions for users, and other customizable settings associated with communications delivered to users.

A content presentation module 114 may provide content to users of a content management system 100, including photos, videos, text, and graphics. The content presentation module 114 provides content for display within web browsers. Content may be displayed using various methods, such as JavaScript, Node.js, AJAX, and other methods of providing data via browsers. In one embodiment, the content delivered by the content presentation module 114 may be stored and retrieved from the content store(s) 116 through a web server 210. Similarly, the content presentation module 114 may provide content via an application natively operating on mobile devices, such as wearable devices and mobile phones. Mobile devices may require APIs to receive data from the content management system 100. The content presentation module 114 may present data for display through these APIs. In one embodiment, the content delivered by content presentation module 114 may be stored and retrieved from a content store 116, a user store 118, an interest store 218, ad network systems 216, partner systems 104, and/or other data sources accessible by the content management system 100 through network 204.

An API management module 206 may manage one or more adapters needed for the content management system 100 to communicate with various third party systems, such as ad network systems 216 and partner systems 104. Application programming interfaces (APIs), or adapters, may be used to push data to the external tools, websites, and user devices 202. Adapters may also be used to receive data from the external systems. In one embodiment, the API management module 206 manages the amount of connections to the external systems needed to operate efficiently.

A content presentation module 114 may retrieve content associated with one or more partner systems 104 from a content store 116 and arrange the subscribed content for display to users of the content management system 100. For example, the content may be arranged in an infinite scrolling feed on a mobile application, an application configured to operate on a platform such as a social networking system, notifications on a mobile operating system, an email digest delivered to users, and so forth. A content presentation module 114 may deliver content to users based on preferences and/or perceived browsing mode. For example, a user browsing content items that are related to fashion may be more inclined to view photo content, such as photos of purses, clothing, cars, etc. However, a user browsing content related to technology may be more inclined to view video content, such as a video review of the newest gadget or car. A user's perceived browsing mode may be inferred by an interest module 112 in one embodiment. In another embodiment, a user's interest in fashion, for example, may be extracted from a subscription to a clothing retailer whereas a user's interest in technology, as another example, may be extracted from clicks and opens of content related to technology in a newsletter.

A content population module 110 may populate user accounts with content items associated with one or more partner systems 104. Unopened emails and/or subscriptions may be provided to a content management system 100 by a partner system 104. In another embodiment, other content may be delivered to the content management system 100 for populating the newly created accounts of disengaged users. In one embodiment, a content population module 110 may populate content in the accounts of disengaged users with related content based on interests of users. In this way, users may discover content that may be useful to the user. In another embodiment, related content may be sponsored by content publishers to be populated in a user's account based existing subscriptions to brand partners and/or interests associated with the user. In a further embodiment, sponsored content may be presented as suggested content or content recommendations in the content management system 100. In yet another embodiment, content may be pushed directly to users through various applications as provided by the content presentation module 114 and the content population module 110 instead of through the users' email addresses. In this way, email content has been made more social through the use of social actions such as sharing, liking, following, and engaging with content in a feed.

An interest module 112 may associate interests stored in the interest store 218 with user profiles stored in the user store 118. In one embodiment, interests may be categorized by partner systems 104 publishing content. For example, metadata tags may be associated with emails in header files. Other metadata content may be extracted from content, such as deals expiring soon, special offers, and promotional codes or coupons. Using these interests extracted or retrieved from subscribed content, an interest module 112 may associate the extracted interests with the users subscribing to and interacting with the delivered content items.

A content analytics module 212 may track and generate metrics regarding content delivered to users through the content management system 100. Various statistical methods may be used to identify content that reached users, convincing them to click on links included in messages, open messages, click-through rates, and so forth. A content analytics module 212 may also provide a holistic view of a user based on aggregated interests. For example, a user may be subscribed to multiple brands, follows brands, scrolls through feeds that include content from related brands and/or interests, opens and/or installs a mobile application and/or application hosted on a social networking system, and whether a user synchronizes an email account with the content management system 100, giving permission to the content management system 100 to provide a script that organizes a user's emails into folders accessible and maintained by the content management system 100.

An ad targeting module 214 may use interests associated with user profiles stored in the user store 118 to target advertisements and/or sponsored content for delivery to users of the content management system 100 through the content presentation module 114, in one embodiment. Demographic information and location information included in user profiles stored in the user store 118 may be used by advertisements for targeting criteria. In addition, the interests extracted from a user's subscriptions and inferred by user clicks and interactions with content on the content management system 100 may be used for targeting criteria by the ad targeting module 214. As an example, a user subscribing to a sporting goods retailer based on a recent purchase of a surfboard may be identified as a surfer. In one embodiment, the partner system 104 associated with the sporting goods retailer may pass a metadata tag identifying “surfing” as an interest to be associated with the subscribing user. In another embodiment, the term “surfing” may be included in the subscribed content published and presented to the user. As a result, the “surfing” interest may be associated to the user's profile in the user store 118. In the interest store 218, the interest “surfing” may be associated with the broad category interests of “sporting,” “travel,” and “beach.” As a result, the user may be targeted with advertisements by the ad targeting module 214 that include interests of “surfing,” “sporting,” “travel,” and/or “beach,” in an embodiment. In one embodiment, an interest in “surfing” may be associated with an interest in “skateboarding” by an interest module 112. As a result, a user may be targeted for an interest in “skateboarding” based on the interest in “surfing.”

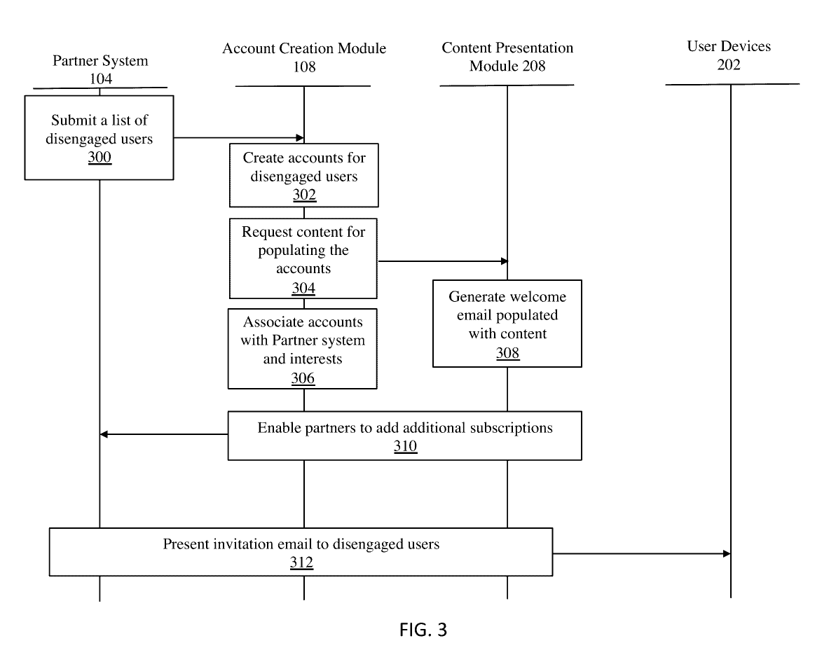

FIG. 3 is an interaction flow diagram illustrating a process for automated subscriber engagement in a content management system, according to an embodiment. A partner system 104 submits 300 a list of disengaged users to an account creation module 108 as part of a request to automatically create accounts in the content management system. The account creation module 108 creates 302 accounts for disengaged users. The account creation module 108 then requests 304 content for populating the accounts. The account creation module 108 also associates 306 the accounts with partner system and interests. The requested content is provided to the content presentation module 208 to generate 308 an invitation email populated with the content. The content presentation module 208 and account creation module 108 then enable 310 partners to add additional subscriptions for the newly created accounts for populating additional content in the invitation email. The partner system 104 then presents 312 the invitation email to disengaged users.

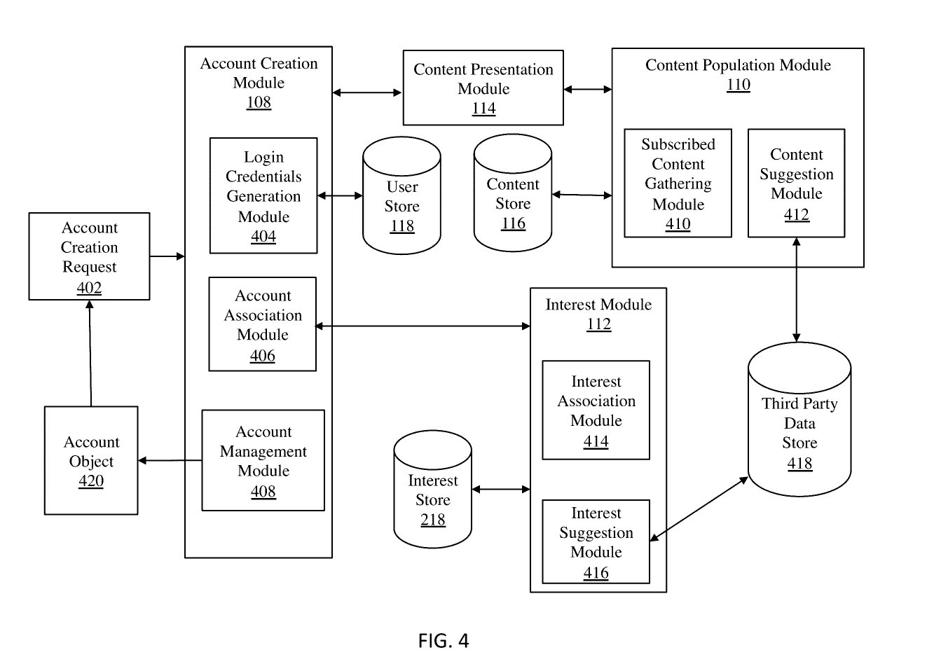

FIG. 4 is a high-level block diagram illustrating a process for automated subscriber engagement in a content management system, according to an embodiment. An account creation request 402 is received by the account creation module 108. The account creation module 108 may include a login credentials generation module 404, an account association module 406, and an account management module 408. The login credentials generation module 404 may generate an account login username based on a disengaged user's email address. For example, the text before the ‘@’ symbol in the email address may be used as the username for the newly created account. The login credentials generation module 404 compares the text before the ‘@’ symbol with other usernames already stored in the user store 118. If the username already exists in the content management system 100, the login credentials generation module 404 may append a number to the text before the ‘@’ symbol to generate a unique username. Other methods of username generation may be used in other embodiments, such as using the name of the disengaged user appended to a randomized number. Additionally, the login credentials generation module 404 may generate a password for the newly created account.

An account association module 406 may associate interests to a newly created account based on the account creation request 402 and interest information from an interest module 112. An interest module 112 may include an interest association module 414 and an interest suggestion module 416. The interest association module 414 may determine an interest from an interest store 218 to be associated with the newly created account based on the account creation request 402. For example, an interest in the partner system 104 brand and one or more interests associated with the brand and/or content items subscribed to by the disengaged user may be associated by the interest association module 414. An interest suggestion module 416 may be used to identify related or inferred interests based on the associated interests of the newly created account. A third party data store 418 and/or an interest store 218 may be used to identify the related and/or inferred interests. A third party data store 418 may be accessed through a network 204, in one embodiment. For example, an ad network system 216 may host a third party data store 418 that includes interests structured to identify related or inferred interests.

Once an account is generated by the account creation module 108, a notification may be sent to the content presentation module 114 to request that content be populated in the newly created account. The content population module 110 may include a subscribed content gathering module 410 and a content suggestion module 412. The subscribed content gathering module 410 may request content items from the content store 116 identifying a number of unopened content items that the disengaged user has subscribed to but has not engaged. In one embodiment, a threshold number of unopened content items is used to determine how many content items to populate the newly created account. In another embodiment, a content suggestion module 412 may determine one or more content items from a third party data store 418 or the content store 116 based on the interests associated with the newly created account.

An account management module 408 may be used to generate, maintain, and/or delete an account object 420 associated with the account creation request 402. An account object 420 is automatically generated based on an account creation request 402. The account object 420 may be stored in a user store 118, in one embodiment. The account object 420 may include a user profile that is associated with one or more interests, as associated by the account association module 406. An account should be activated by the disengaged user to remain in the content management system 100, in an embodiment. The account management module 408 may provide an interface for a user of the content management system 100 to modify interests, edit subscriptions, and/or delete the account object 420 generated by the account creation module 108. The account management module 408 may also automatically delete an un-activated account after a predetermined time period. Upon deletion, the account object 420 is marked for deletion in the user store 118, in one embodiment.

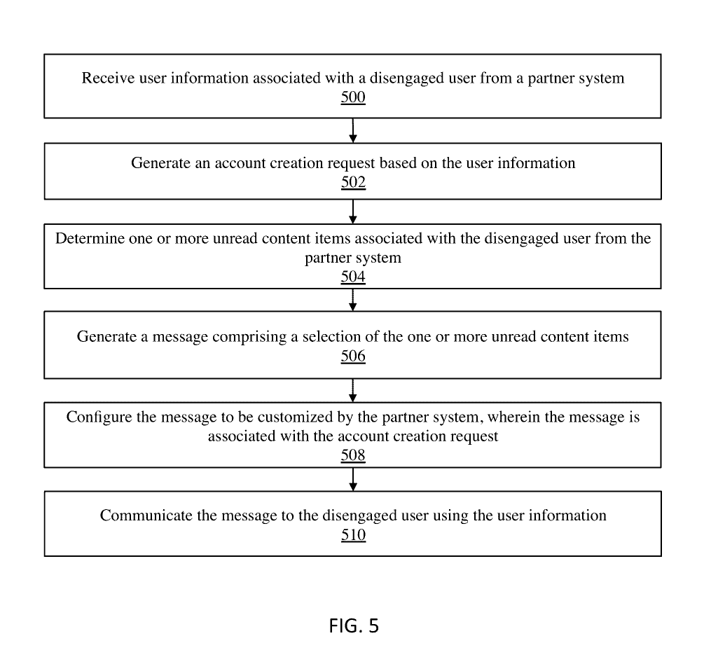

FIG. 5 is a flow chart of a process for engaging subscribers using a content management system, according to some examples. User information associated with a disengaged user is received 500 from a partner system. User information may include an email address associated with the disengaged user. Other types of user information may further include contact information such as phone numbers, mailing addresses, social media handles, websites, location information, work information, demographic information including age and gender, and the like.

An account creation request is generated 502 based on the user information. The account creation request may include interest information based on the partner system associated with the disengaged user. The account creation request may also include the user information received 500 from the partner system. One or more unread content items associated with the disengaged user is then determined 504 from the partner system. The one or more unread content items may be determined 504 by receiving the unread content items from the partner system, in an embodiment. In another embodiment, the unread content items are retrieved from the content store 116. In a further embodiment, the unread content items may be determined 504 by including suggested content items based on related and/or inferred interests associated with the disengaged user.

A message comprising a selection of the one or more unread content items is generated 506. For example, an invitation email message may include a selection of the one or more unread content items identified by the content management system 100. In one embodiment, that message may include the 5 most recent published content items that were not opened by the disengaged user, as identified and tracked by the partner system. In another embodiment, a different number of unopened content items may be selected based on an interest of the disengaged user. In another embodiment, sponsored content items may be included in the message that is generated 506. The sponsored content items may be targeted to the disengaged user based on interest(s) associated with the disengaged user.

The message may then be configured 508 to be customized by the partner system, wherein the message is associated with the account creation request. Other content items may be included based on a partner system opting to include additional subscription content that may be related to the unread content items associated with the disengaged user. The message may be configured 508 to be customized by enabling a partner system to edit content items selected for presentation to the disengaged user, edit the arrangement of the content items, and/or opt the disengaged user in or out of subscriptions. Further, the message may be configured to be customized by adding personalized details about the disengaged user, such as using the disengaged user's first name in the greeting of the invitation message (e.g., “We miss you Michael!”). The message may then be communicated 510 to the disengaged user using the user information. In one embodiment, the message is communicated 510 through the email address associated with the disengaged user. In another embodiment, the message may be communicated 510 through any communication channel available to the content management system 100 based on the user information. For example, the message may be a format of a notification on a mobile device, a text message, a pop up advertisement through an ad network, and the like.

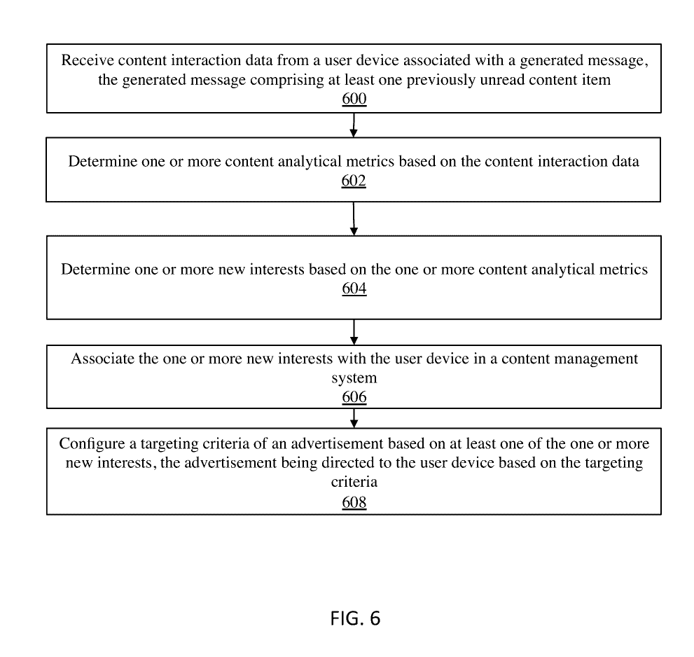

FIG. 6 is a flow chart of a process for targeting subscribers for advertising using a content management system, according to some examples. Content interaction data may be received 600 from a user device associated with a generated message, the generated message comprising at least one previously unread content item. For example, if the user device opened the generated message, the indication of the opening of the message may be received 600 as content interaction data. Other types of content interaction data that may be received 600 include clicks on links, forwards of the generated message, replies to the generated message, and deletion of the generated message, in various embodiments.

One or more content analytical metrics may be determined 602 based on the content interaction data. The one or more content analytical metrics may include clickthrough rates, heat maps of clicks on the generated message, and statistical metrics tracked by the content management system 100 such as time of day with most opens, time elapsed since last interaction, and so forth. One or more new interests may be determined 604 based on the one or more content analytical metrics. For example, if a content item that was interacted with is related to one or more interests, those interests may be determined 604 and identified based on the interaction.

The one or more new interests may then be associated 606 with the user device in a content management system. For example, the new interests may be associated 606 with a user profile associated with the user device. The user profile may be stored in the user store 118 as an account object 420 generated automatically by the content management system 100. A targeting criteria of an advertisement may then be configured 608 based on at least one of the one or more new interests, the advertisement being directed to the user device based on the targeting criteria. The advertisement may be directed to the user device through various platforms, including the content management system 100. For example, the advertisement may be directed to the user device through an ad network, in one embodiment. In another embodiment, an advertisement may be placed among selected content items published to the user device. In a further embodiment, an advertisement may be a sponsored subscription to a partner system.

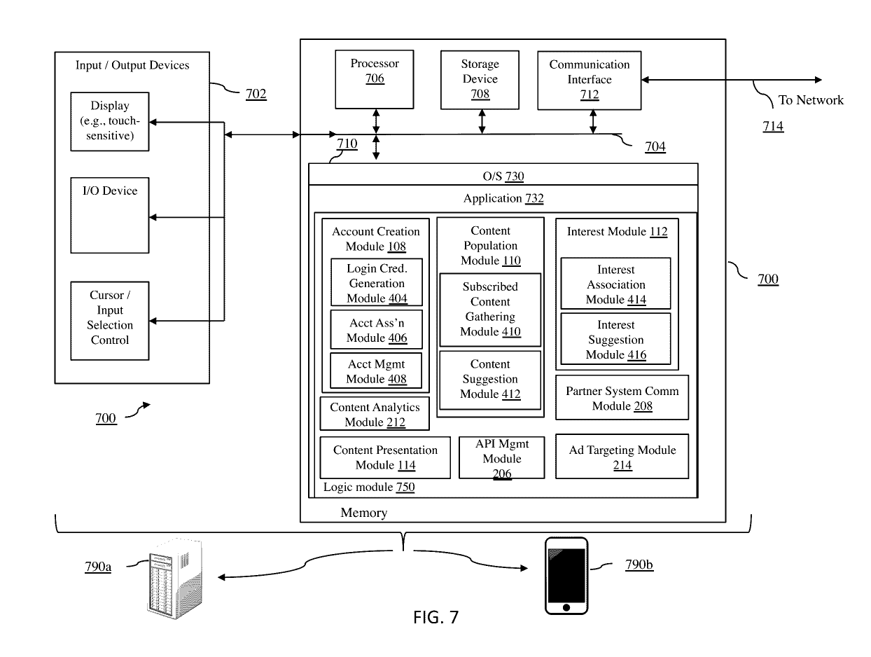

FIG. 7 illustrates an exemplary computing platform disposed in a device configured to provide automated subscriber engagement in accordance with various embodiments. In some examples, computing platform 700 may be used to implement computer programs, applications, methods, processes, algorithms, or other software to perform the above-described techniques.

In some cases, computing platform can be disposed in wearable device or implement, a mobile computing device 790b, or any other device, such as a computing device 790a.

Computing platform 700 includes a bus 704 or other communication mechanism for communicating information, which interconnects subsystems and devices, such as processor 706, system memory 710 (e.g., RAM, etc.), storage device 708 (e.g., ROM, etc.), a communication interface 712 (e.g., an Ethernet or wireless controller, a Bluetooth controller, etc.) to facilitate communications via a port on communication link 714 to communicate, for example, with a computing device, including mobile computing and/or communication devices with processors. Processor 706 can be implemented with one or more central processing units (“CPUs”), such as those manufactured by Intel® Corporation, or one or more virtual processors, as well as any combination of CPUs and virtual processors. Computing platform 700 exchanges data representing inputs and outputs via input-and-output devices 702, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 700 performs specific operations by processor 706 executing one or more sequences of one or more instructions stored in system memory 710, and computing platform 700 can be implemented in a client-server arrangement, peer-to-peer arrangement, or as any mobile computing device, including smart phones and the like. Such instructions or data may be read into system memory 710 from another computer readable medium, such as storage device 708. In some examples, hard-wired circuitry may be used in place of or in combination with software instructions for implementation. Instructions may be embedded in software or firmware. The term “computer readable medium” refers to any tangible medium that participates in providing instructions to processor 706 for execution. Such a medium may take many forms, including but not limited to, non-volatile media and volatile media. Non-volatile media includes, for example, optical or magnetic disks and the like. Volatile media includes dynamic memory, such as system memory 710.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 704 for transmitting a computer data signal.

In some examples, execution of the sequences of instructions may be performed by computing platform 700. According to some examples, computing platform 700 can be coupled by communication link 714 (e.g., a wired network, such as LAN, PSTN, or any wireless network, including WiFi of various standards and protocols, Blue Tooth®, Zig-Bee, etc.) to any other processor to perform the sequence of instructions in coordination with (or asynchronous to) one another. Computing platform 700 may transmit and receive messages, data, and instructions, including program code (e.g., application code) through communication link 714 and communication interface 712. Received program code may be executed by processor 706 as it is received, and/or stored in memory 710 or other non-volatile storage for later execution.

In the example shown, system memory 710 can include various modules that include executable instructions to implement functionalities described herein. System memory 710 may include an operating system (“O/S”) 730, as well as an application 732 and/or logic module 750. In the example shown, system memory 710 includes an account creation module 108 including a login credentials generation module 404, an account association module 406, and an account management module 408. The system memory 710 may also include a content population module 110 that further includes a subscribed content gathering module 410 and a content suggestion module 412. The system memory 710 may further include an interest module 112 that further includes an interest association module 414 and an interest suggestion module 416. The system memory 710 may also include a content presentation module 114, a content analytics module 212, an API management module 206, a partner system communication module 208, and an ad targeting module 214. One or more of the modules included in memory 710 can be configured to provide or consume outputs to implement one or more functions described herein.

In at least some examples, the structures, modules, and/or functions of any of the above-described features can be implemented in software, hardware, firmware, circuitry, or a combination thereof. Note that the structures, modules and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a listing management system or one or more of its components, or any process or device described herein, can be in communication (e.g., wired or wirelessly) with a mobile device, such as a mobile phone or computing device, or can be disposed therein.

In some cases, a mobile device, or any networked computing device (not shown) in communication with an action alert controller or one or more of its components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, an account creation module 108 or any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, a content management system, including one or more components, or any process or device described herein, can be implemented in one or more computing devices that include one or more circuits. Thus, at least one of the elements in the above-described figures can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
receiving, in a content management system, user information associated with data specifying a disengaged user account from a partner system;
generating an account creation request based on the user information;
determining one or more unopened content items associated with the disengaged user from the partner system;
generating an electronic message comprising a selection of the one or more unread content items;
configuring the electronic message to be customizable, wherein the electronic message is associated with the account creation request; and
communicating the electronic message to a computing device associated with the disengaged user account using the user information.

2. The method of claim 1, wherein generating an account creation request based on the user information further comprises:
extracting a prefix from an email address associated with the disengaged user account;
determining a username based on the prefix, the username associated with the disengaged user account; and
automatically generating an account with the username in the content management system.

3. The method of claim 2, the method further comprising:
generating a login password associated with the account and the username, wherein the electronic message is further configured to include at least one of the username and the login password and a link to activate the account.

4. The method of claim 1, wherein generating the electronic message further comprises:
extracting from the one or more unopened content items a plurality of images and a plurality of text; and
formatting the extracted plurality of images and the extracted plurality of text into the electronic message, wherein the formatting is adapted to be presented in a mobile application form factor.

5. The method of claim 1, wherein configuring the electronic message to be customizable further comprises:
providing in the electronic message programmable code configured to, responsive to receiving an indication of a user interaction with the electronic message, the user interaction comprising a scroll action, retrieve an additional content item from the partner system to be included in the electronic message.

6. The method of claim 1, wherein at least one content item of the one or more unopened content items associated with the partner system comprises a data attribute interest associated with a brand.

7. The method of claim 6, wherein configuring the electronic message to be customizable further comprises:
providing in the electronic message programmable code configured to, responsive to receiving an indication of a user interaction with the electronic message, the user interaction comprising a scroll action, retrieve an additional content item from the partner system to be included in the electronic message, wherein the additional content item is associated with the data attribute interest associated with the brand.

8. The method of claim 1, wherein the one or more unopened content items comprise at least one suggested content item, the method further comprising:
providing in the electronic message programmable code configured to include an additional content item from the partner system to be included in the electronic message, wherein the additional content item is associated with the at least one suggested content item based on the user information including an interest.

9. A method, comprising:
receiving content interaction data from a user device associated with a generated message, the generated message comprising at least one unopened content item;
determining one or more content analytical metrics based on the content interaction data;
determining one or more data attributes representing interests based on the one or more content analytical metrics;
associating the one or more data attributes representing interests with the user device in a content management system; and
configuring a targeting criteria of an advertisement based on at least one of the one or more data attributes representing interests, the advertisement being directed to the user device based on the targeting criteria.

10. The method of claim 9, further comprising:
delivering the advertisement to the user device.

11. The method of claim 9, wherein the content interaction data comprises an indication of the generated message being opened.

12. The method of claim 9, wherein the content interaction data comprises an indication of a user interaction within the generated message.

13. The method of claim 9, wherein the one or more content analytical metrics comprises a click-through rate.

14. The method of claim 9, wherein the one or more data attributes representing interests are determined based on a third party data source.

15. A method, comprising:
receiving a list of disengaged user accounts from a partner system and associated content information items, each disengaged user account associated with a contact information item in the list;
generating a user profile associated with each disengaged user account, each user profile comprising at least one data attribute representing an interest associated with the partner system;
generating an account object associated with each disengaged user account in a content management system, the account objects stored in a user store, wherein the account objects are associated with the user profiles;
configuring a message associated with delivery to the disengaged users, the message comprising a plurality of unopened content items associated with the partner system; and
receiving an activation indication responsive to the message, the activation indication comprising user interactions with the message.

16. The method of claim 15, wherein the message comprises an activation link and the activation indication comprises a user interaction with the activation link.

17. The method of claim 15, wherein the message comprises a suggested content item based on the plurality of unopened content items associated with the partner system.

18. The method of claim 17, wherein the suggested content item is a sponsored content item based on the at least one data attribute representing the interest.

19. The method of claim 15, wherein the unopened content items comprises subscription emails.

20. The method of claim 15, wherein the message comprises an advertisement.
